(19) United States
(12) Patent Application Publication
(10) Pub. No.: US 2007/0047438 A1
(43) Pub. Date: Mar. 1, 2007

(54) Identifying a transaction of interest within a network

(76) Inventors: Patrick J. Malloy, Washington, DC (US); Russell Mark Elsner, Bethesda, MD (US); John W. Strohm, Rockville, MD (US); Alain J. Cohen, Washington, DC (US); Steven Niemczyk, Bethesda, MD (US); Marc I. Schneider, Arlington, VA (US)

Correspondence Address: ROBERT M. MCDERMOTT, ESQ., 1824 FEDERAL FARM ROAD, MONTROSS, VA, 22520, US

(21) Appl. No.: 11/506,649

(22) Filed: Aug. 18, 2006

Related U.S. Application Data
(60) Provisional application No. 60/709,721, filed on Aug. 20, 2005.

(51) Int. Cl. H04L 12/26

(52) U.S. Cl. 370/230; 370/235; 370/392

(57) ABSTRACT

Transactions within a transmission stream are identified that are related to an activity. The transactions are classified utilizing characteristics that identify the activity. Packets of the transaction are extracted from the transmission stream that corresponds to the activity. The extracted packets are presented in a visualization that identifies the packets and source and sink devices of the packets. The packets may be identified from a network trace. Classifying transactions includes identifying patterns present in packets to identify related transactions and/or packets that are temporally correlated. The characteristics may include heuristics related to a communication protocol of the transactions, examining temporal relationships of the packets, and/or identifying DNS requests related to the packets. The extracted packets may be presented as a tier pair circle wherein related devices are presented around a circumference of the tier pair circle and packet traffic between devices is indicated by a joining line.

This application claims the benefit of U.S. Provisional Patent Application No. 60/709,721, filed Aug. 20, 2005.

### BACKGROUND AND SUMMARY OF THE INVENTION

The present system relates to the field of network analysis and particularly to identifying a transaction of interest within a network.

There are many systems that exist that enable a trace of a particular transmission from a network node that originated the transmission to a destination node. A simple means for performing such a trace is by pinging the destination node. Pinging is an act of sending a packet to the destination node, such as a specified Internet Protocol (IP) address, and then waiting for a reply. Depending on the utility utilized for pinging, information may be returned including information on transmission time between nodes, intermediate routers traveled between nodes, whether packets were lost during the transmission, etc. The trace is used to provide information about Internet connections for example as a routine during troubleshooting, network setup, configuration management, predictive analysis and other operations of the like.

Although pinging is a very useful way of getting very basic information on transmission paths of a network, oftentimes this information is not sufficient to assist in a particular inquiry into the operation of a network. Network communications on a large scale, such as over the Internet, entail transfers of large numbers of packets that are strung together to form a data stream. As a result of the stringing process, related packets oftentimes are not positioned contiguously within the data stream. Accordingly, analysis of packet transfers requires identification of related packets, for example identified through header information, which uniquely identifies packets as being related. While this process is simplified by the packet header, it provides no assistance in analyzing transmissions that are related but are not part of a same transaction stream. For example, often an individual user-level action between two hosts (e.g., a client and server) consists of multiple transactions, which in turn may consist of many messages including many network packets. For example, if a user on a client machine issues a single request to a server, many individual connections and messages may be exchanged between the client and the aforementioned server and even possibly other servers. When a browser clicks on a button within a web page, network traffic between a client node wherein the browser is active and a server that is hosting the web page may involve much more than a simple request and response transaction such as a ping. For example, activities such as the server accessing other sites may result from embedded links present on the accessed web page. However, prior systems may not properly identify these additional transactions as being part of the same transaction stream.

Analysis of the performance of a network requires examining network traffic that may be directly or indirectly related to an activity of interest. Existing systems attempt to identify these related packets yet require an analyst to specifically identify related data packets or require network conditions that do not closely mirror actual working conditions. For example, often great care is taken to obtain network traffic in idealized conditions where other unrelated traffic is removed from the system. This may assist in identifying related transactions thereby improving the accuracy of the trace. However, this system may gain the above advantage but at the expense of removing an ability to identify network issues that may be related to the additional transactions, such as issues normally occurring related to network congestion. In addition, this prior system provides no ability to analyze a transaction under actual working conditions.

It is an object of the present system to overcome disadvantages and/or make improvements in the prior art.

The present system includes a system, method and device for identifying transactions within a transmission stream that are related to an activity. In operation, transactions are classified utilizing characteristics that identify the activity. Packets of transactions are extracted from the transmission stream that corresponds to the activity. The extracted packets are presented in a visualization that identifies the packets and source and sink devices of the packets. The packets may be identified from a network trace.

In one embodiment, the transactions occur as a result of a user-level action (ULA). In accordance with the present system, a ULA may be as little as a single user action that may result in a propagation of one or more related transactions and packets making up the transaction. A related transaction as utilized herein includes not only a direct request/response between a client and a server, but also other transactions that occur as a result and thereby, are classified as occurring due to the ULA. Classifying transactions may include identifying patterns present in packets to identify related transactions and/or identifying packets that are temporally correlated. The characteristics may include, for example, heuristics related to a communication protocol of the transactions, temporal relationships of the packets, and/or identified characteristics of DNS requests related to the packets. For example, packets may be extracted by identifying DNS requests for a first IP address that occur in temporal proximity to an application request related to the activity.

Two of a plurality of activities may be connected as a single activity by identifying a related subsequent user action. Packets may be extracted by correlating a key present in the packets to a common activity of the plurality of activities. Traffic may be correlated across multiple tiers as part of a common activity, for example if packets in one tier pair cause corresponding packets in other tier pairs.

The extracted packets may be visualized as a tier pair circle wherein related devices are presented around a circumference of the tier pair circle and packet traffic between devices is indicated by a joining line. The joining line may be provided with a visual characteristic that indicates a characteristic of related packet traffic. The visual characteristic may include a color and/or thickness of the joining line. A user selection of a link within the visualization may alter the visualization to provide details related to a selected source and sink of the selected link. A graph may be added to the visualization to provide the details. In another embodiment, the user selection may be provided by selecting a temporal period of interest. The user interaction with this visualization may be used to further refine the set of packets belonging to a single user level action (ULA).

### BRIEF DESCRIPTION OF THE DRAWINGS

The invention is explained in further detail, and by way of example, with reference to the accompanying drawings wherein:

FIG. 1 shows an illustrative flow diagram of a process in accordance with an embodiment of the present system;

FIG. 2 shows details of an illustrative network visualization including a tier pair circle in accordance with an embodiment of the present system;

FIG. 3 shows details of an illustrative network visualization including a graph of network throughput in accordance with an embodiment of the present system;

FIG. 4 shows details of an illustrative network visualization including details on individual packets in accordance with an embodiment of the present system;

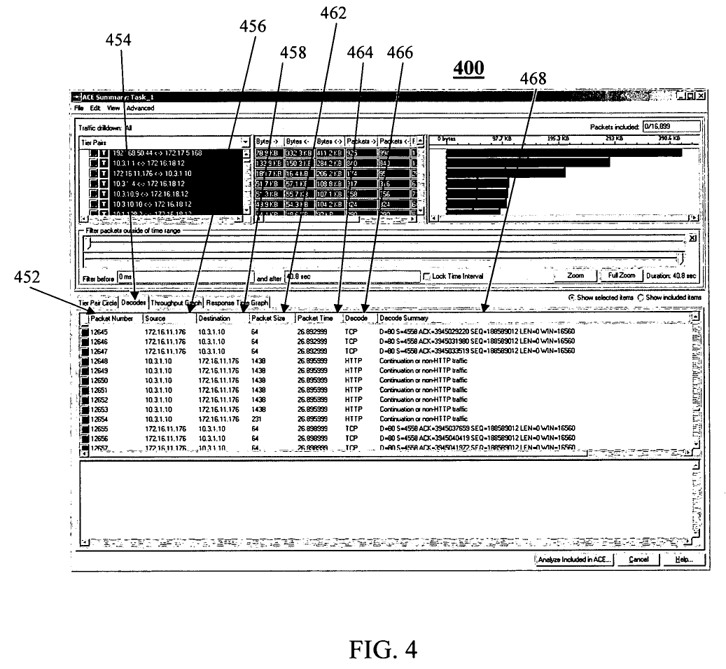

FIG. 5 shows details of an illustrative network visualization including a response time graph in accordance with an embodiment of the present system; and

FIG. 6 shows a system for performing the acts and providing a network visualization in accordance with an embodiment of the present system.

### DETAILED DESCRIPTION

The following are descriptions of illustrative embodiments that when taken in conjunction with the following drawings will demonstrate the above noted features and advantages, as well as further ones. In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system.

The system and method described herein address problems in prior art systems. The method in accordance with the present system facilitates identification and classification of packets that are related to a same transaction stream (e.g., related activities) that result from a user level action without requiring an elimination of other packets within the stream. As such, the present system provides a means for identifying and classifying related activities and transaction that are represented by network traffic. In this way, information such as traces collected from one or more connected computer networks may be analyzed to identify which packets, messages and transactions within the network are related to a common task initiated by a client, such as for example a user-level action (ULA).

Unlike prior systems wherein often great care was required to obtain network traffic in idealized conditions where other unrelated traffic was removed from the system, the present system enables analysis of network transactions under true operating conditions without a need to stop unrelated transactions from the network. Accordingly, transaction extraction in accordance with the present system may eliminate the additional effort required to obtain these idealized network conditions.

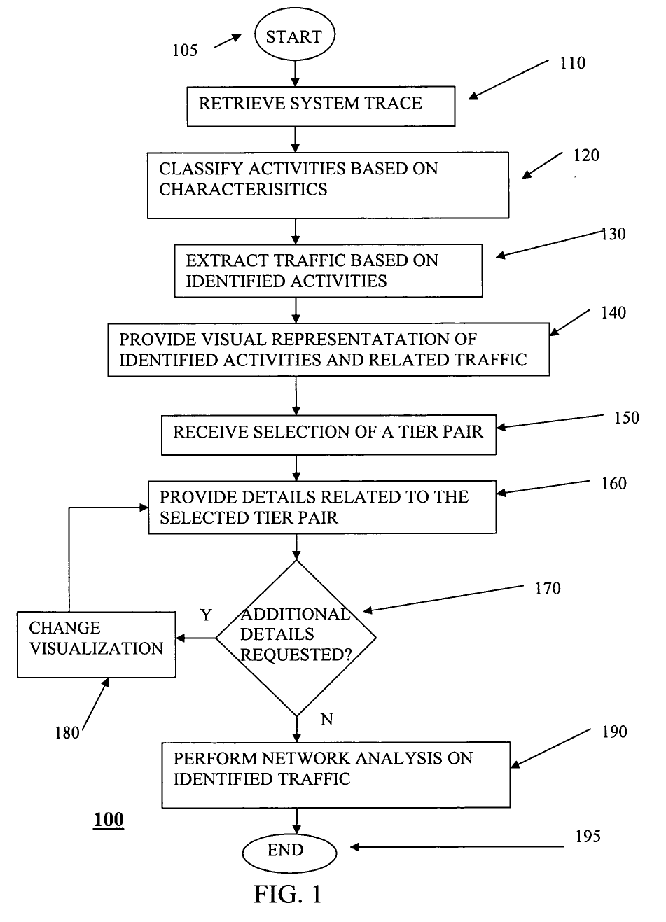

FIG. 1 shows an illustrative flow diagram 100 of a process in accordance with an embodiment of the present system. The process starts during act 105. Packet data may be retrieved during act 110 to enable classifying transactions during act 120 on a network. Related network traffic is extracted during act 130 based on the classified transactions. A visual representation of identified activities and related traffic is provided during act 140. A selection of data of interest may be provided by a user during act 150 where after, the system may provide details relating to the selection during act 160. In a case wherein additional details are requested during act 170, the visualization is updated during act 180 and the additional details are provided during act 160, etc. In this embodiment, when no additional details are requested during act 170, network analysis may be performed on identified network traffic during act 190. The process thereafter ends during act 195.

Classification is a process of organizing user-level actions based on characteristics of the actions, such as task, goal, client, etc. Extraction is the process of identifying the network traffic (packets, messages, transactions, etc.) that occur as a result of the user-level actions, such as one or more ULAs, and separating them from the rest of the traffic based on results from the classification process.

In accordance with the present system, network traffic may be separated by classifying the traffic as corresponding to class sets that identify typical activities or characteristics of the traffic. For example one classification of interest may be user-level actions (ULAs). As stated above, the classification of traffic facilitates the identification of related network activity and may also be utilized to highlight different aspects of the traffic. As such, each classification may also be used to help identify key metrics of network performance during act 160.

In network performance analysis, each transaction may be analyzed for its performance across multiple settings. Identifying which packets across multiple hosts are related to each other requires some understanding of how information, such as packets, is transferred across a network. A network trace is a file containing records representing network packets including information identifying a path of the packets, a transmission protocol and other information related to the packets transmission through the network. In accordance with an embodiment of the present system, information stored in a network trace may be retrieved during act 110.

A network trace is a file obtained by performing a packet capture, where a software and/or hardware tool monitors activity on a network and records information to the network trace file corresponding to the packets observed on the network. However, this information from the trace generally relates to a larger grouping or smaller grouping (e.g., a ping) of communications than those particularly related to a given activity. In accordance with the present system, the network trace files may be examined to correlate the packets to transactions and user level actions as described herein.

The present system in accordance with an embodiment isolates packets, messages and transactions associated with an action, such as a single ULA, that is performed by a user of the network based application (e.g. clicking a button on a web page). However, network traces captured in real-world production environments typically include many packets, messages and transactions that may result from many different ULAs intermixed in the trace. In accordance with the present system, packets, messages and transactions associated with a ULA of interest are isolated from non-related portions of the trace.

In one embodiment in accordance with the present system, patterns present in traffic may be used to automatically identify related packets from the trace file. For example, protocol information may be used to automatically identify transaction classes to separate network traffic by common communication protocols, such as HyperText Transfer Protocol (HTTP) and TNS.

Traffic may be temporally correlated by automatically identifying traffic from/to a common node/client/host in time. In this way, all traffic that is within a given time frame of other traffic in the connection may be said to be related. For example, if a gap in time between traffic from a given host exceeds a threshold, such as plus or minus five (5) seconds, the traffic may be automatically classified as resulting from an unrelated ULA. This threshold may be customized and selectable by the user. In addition, more sophisticated techniques for identifying pauses in traffic may be used together with the threshold or in place of it in accordance with the present system to identify related transactions or conversely to exclude unrelated transactions. For example, a threshold may be utilized as discussed above together with an additional threshold time to identify related traffic. In this way, traffic due to a response may be properly classified as related. Other variations of temporal classification would readily occur to a person of ordinary skill in the art and are intended to be encompassed by the present system.

To understand and analyze network application behavior and performance, it is important to identify individual transactions on the network and related transactions. When presented with unlabeled network traffic by itself, clustering this traffic into related transactions is a challenging problem. Making reasonable assumptions about the behavior of traffic in many cases may produce groupings that match closely (if not exactly) with a true grouping of the transactions (e.g., transactions that are related to a ULA).

Certain heuristics about the nature of Transmission Control Protocol (TCP) traffic may give an indication of which traffic corresponds to a same activity. TCP is one of the main communication protocols in TCP/IP networks and enables two hosts (e.g., a client and server) to establish a connection and exchange streams of data. An example of a heuristic relating TCP traffic to user-level actions assume traffic on the same connection to be related to the same ULA, and those from other connections to be related to other ULAs.

For an extraction of traffic that is related to ULAs, reasonable assumptions may be utilized that produce groupings that may match or closely match a true grouping of the activities. For example, an individual user-level action between two hosts (e.g., a client and server) may result in multiple transactions consisting of many messages and many network packets. For example, if a user on a client machine issues a single request to a server, for example by clicking on a button on a web page, many individual connections and messages may be exchanged between the client and the aforementioned server as well as possibly other servers. In accordance with a present embodiment, all the components (e.g., transactions, packets, etc.) of such a ULA may be identified and extracted.

Illustratively, a “two-tier extraction” of related packets etc. is described herein which relates to a single client and server exchange. However, as would be apparent to a person of ordinary skill in the art, the system and process described herein also readily applies to a client communicating with multiple servers. For example, in a particular activity such as a web browser running on a client accessing a main page stored on a given web server, embedded images from a further web server etc., may also be accessed. Regardless of the levels of tiers accessed, the present system is enabled to extract all related traffic and classify the extracted traffic as being related to an activity of interest.

An example of a two-tier ULA extraction may involve an interaction between a user and a browser on a given client as discussed above. When the user clicks on a link or opens a web page, two or more hosts may be involved in fulfilling this request even across multiple protocols. For example, a user may initiate a request to access a particular web site by entering a name of the web site into a web browser address bar, such as a World Wide Web (www) address opnet.com. In response, the client machine issues a Domain Name Service (DNS) request to a name server to identify an IP address associated with the hostname opnet.com. An HTTP 1.0 or 1.1 request is sent to the host IP address associated with opnet.com (e.g., 207.234.204.223). HTML text of the main page of the host may be retrieved. The HTML text may make reference to several images or other embedded content (Flash, Java, etc.). All of the images and other embedded content required to completely display the page is retrieved by the client. This content may be located on the same server as the main page, and/or on one or more different servers. In a case wherein the content is located on different servers, other DNS requests will be issued before the related content requests are issued. Conceivably, the embedded content may in turn make reference to other content, located on a same or further hosts, etc. Embedded content may be retrieved by the same protocol as the main page HTTP, or alternatively secure HTTP (HTTPS), FTP, Gopher, RTSP or other protocols supported by the browser. In accordance with the present system, all network traffic related to the user initiated request may be extracted, for example from a trace, and presented, for example by a rendering of an informational page.

The present system envisions multiple approaches to identifying traffic related to a common ULA. Some illustrative approaches are presented however other simple and/or more sophisticated approaches may be used together with the presented approaches or may be used alone to implement such a system in accordance with the present system. In one embodiment in accordance with the present system, multiple approaches will be utilized to filter out unrelated traffic.

Identification of related traffic may occur as a result of identification of related DNS requests. For example, DNS requests for an IP address of a particular hostname name may occur in temporal proximity to application (e.g., HTTP, RTSP) requests made to the address just retrieved. The content of the response (e.g., the HTML of the page requested by HTTP) may contain URL references to additional image and embedded content URLs (e.g., <IMG> and <EMBED> tags). For example, an HTTP GET request of images/photo1.gif occurring soon after a page containing <IMG src=“images/photo1.gif”> may indicate that this request and response is part of the same ULA as the page making reference to the image.

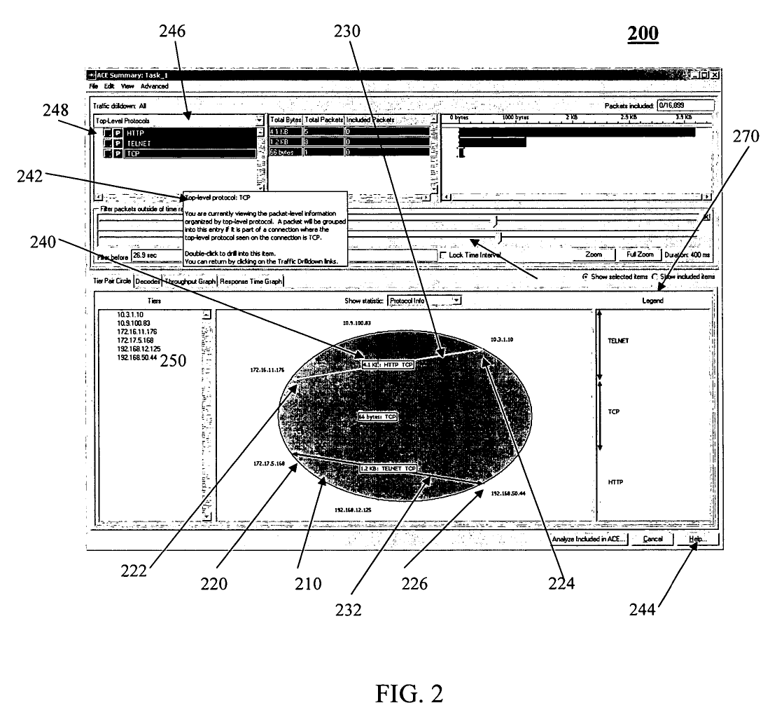

Additionally, other links may be present in the content but only trigger a request if the user selects the other links, such as by “clicking” on a particular link using a mouse and a suitable user interface (e.g., graphical user interface, GUI) as discussed below with regard to FIG. 2. This information may be used to connect ULAs based on subsequent user actions (e.g., clicking on a Help link on the main web page).

Other approaches may be used to identify related traffic. Correlation of text present in the content may identify traffic related to a common ULA. For example, cookies and HTTP request parameters may be interpreted as keys for identifying traffic from a common user-level action. The pattern used for grouping traffic and/or ULAs may be manually specified and/or may be automatically deduced using pattern recognition techniques. For example, related phrases in a page wherein the link, etc. is embedded and a destination page of the embedded link occurring in temporal proximity may be recognized as being grouped in a given ULA. Other variations of textual pattern recognition techniques would occur to a person of ordinary skill in the art and are intended to be within the scope of the present system.

A system may use understanding (e.g., typical patterns) of one or more protocols used in Internet-based applications to determine correlations including but not limited to HTTP, FTP, RTSP, POP, SMTP, etc. Certain programming paradigms may be used to make reasonable assumptions about given tasks. For example, the names of fields and template of certain SQL queries may be used to distinguish requests for single items, such as in a token-following technique described below. TCP based heuristics may also be used, such as using a TCP PUSH flag to identify message boundaries. For certain applications, such as applications that make a single request-response for a ULA, the PUSH flag may be used to identify the ULA boundary. The TCP PUSH flag tells the receiving end of a TCP connection to “push” all buffered data to the receiving application indicating that the transmission of the message is done for now. Other protocol inferences would occur to a person of ordinary skill in the art and are intended to be within the scope of the present system.

An embodiment in accordance with the present system may utilize multiple tier correlation by correlating traffic across multiple tiers as part of the same transaction, for example if messages in one tier pair access corresponding messages in an other tier pair. These correlations may be one to one, many-to-one, many-to-many, and one-to-many.

Multiple tier applications are common in today's networks. Though many configurations apply, a common one places web clients on one tier, a web server located on a second tier, and a database located on a third tier. In this context, “multiple tiers” means a multi-tier application such as a client, web server and database server, rather than a client communicating to multiple front end tiers as described previously.

Often a request is made from the client that will trigger in turn a request from the database. The database will respond to the server, and in turn the server will respond to the client. The mapping function between client->server requests and server->database requests may be deducible automatically from the traffic itself. The same approaches described above for two-tier extraction also apply to multiple tier correlation, as well as the following approaches.

There are many embodiments which may assist in correlating traffic across multiple tiers. Copending U.S. Patent Publication No. US2006/0013228 entitled “PACKET TRACING” incorporated herein as if set out in its entirety teaches the capture of a reference set of transmissions corresponding to a given transaction and a comparison to a larger set of communications in the network to identify an occurrence of target traffic in the network. Copending U.S. Patent Publication No. US2006/0050704 entitled “CORRELATING PACKETS” incorporated herein as if set out in its entirety teaches searching a traffic stream for a sequence of “matching” packets that exhibit a high degree of correlation or similarity to a sequence of reference packets to identify traffic related to an activity.

One approach may utilize payload pattern recognition to identify key information in the payload of requests on both tier pairs and label these as tokens. These tokens may be utilized as such, and/or may be encoded, encrypted or otherwise obscured, and various pattern recognition techniques, such as principal component analysis may be used to identify the relevant tokens. Traffic sharing the token across multiple tiers may be considered belonging to the same activity.

Users may also directly identify regular expressions or other explicit descriptions of how to identify the tokens in a message for example on a particular tier pair. These patterns may be saved for reuse across multiple transactions in the same or similar networks. Token patterns may include transactions such as seeking out HTML parameters, HTTP header information, cookie information, and/or other metadata. In one embodiment in accordance with the present system, each technique may identify traffic portions that may be viewed as individual tokens that when combined form tuples (e.g., ordered pairs of possibly-related metadata) that may be correlated using suitable classification techniques as well as other more sophisticated techniques.

A typical configuration in network traffic may have many clients connecting to a single server, or a pool of servers. Often these servers may be identified automatically. One technique is to identify a common port used across many machines that is used exclusively as the recipient of connections. Servers sending to this port are labeled as clients, and each client may be assumed to be part of separate transactions. All machines receiving connections on this port may be assumed to be servers.

The same technique may be used to further identify tiers that back the server layer. For example, traffic from ephemeral ports on machines labeled servers to well-known ports on other machines may be labeled as database and back-end tiers.

Further operation of the present system will be provided including a discussion of the visualization provided in FIG. 2 which shows an illustrative visualization 200 that may be provided during act 140 of FIG. 1 in accordance with an embodiment of the present system. The visualization 200 is shown depicted in a typical user interface (UI) that may include a windowing environment. Menu items provided may be typical of those in a windowing environment, such as may be represented within a Windows™ Operating System graphical user interface (GUI) as provided by Microsoft Corporation. The objects and sections of the visualization may be navigated during act 150 utilizing a user input device, such as a mouse, trackball and/or other suitable user input. Further, the user input device may be utilized for selecting details of traffic etc. as discussed further herein.

The visualization 200 is illustratively shown depicting a figure of a circle referred to herein as a “tier pair circle” 210. Each tier, network node, etc. may be represented as a point on the circle, such as node points 220, 222, 224, 226. Lines, such as line 230 may connect any tier pairs that have traffic between them. The lines may have line characteristics, such as varying line thickness, be color coded, such as line 230 compared to line 232, be shade differentiated, etc., according to one or more legends 270 to visually display information such as throughput, total amount of bytes or packets transmitted between the nodes, transmission protocol of communication (e.g., TELNET, TCP, HTTP), and other information of the like. Textual labels 240 and tool tips 242 as may be readily understood in the art may also be used to display additional information, such as more detailed information. For example, a textual label may include information relating to a protocol distribution of packets between two given tier pairs and/or other information as may be readily appreciated. A tool tip may be provided by selection of a help button 244 within the GUI 200 or may result as a pop-up window by positioning a cursor in close proximity to a link that is of interest.

A selection of the focus of a given tier pair circle may be altered by a selection area 246, In this embodiment, the tier pair circle may reflect information related to, for example, top-level protocols (as shown in FIG. 2), tier pairs, tiers, connections, requests/responses, end-user transaction, and other information of the like. Highlighting of protocols of interest within a tabular portion 248 may be utilized to eliminate protocols from the tier pair circle 210 that are not currently of interest.

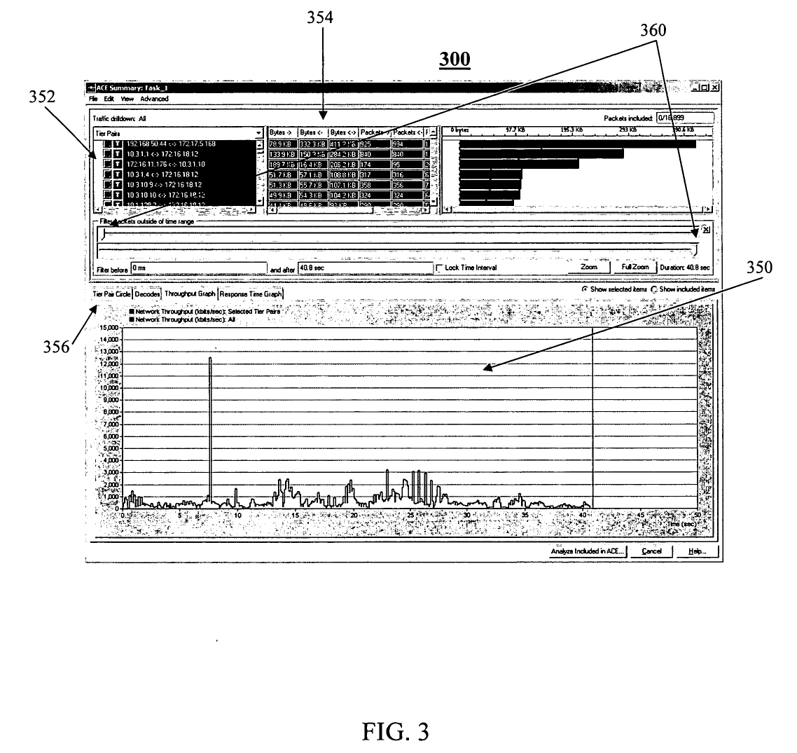

FIG. 3 shows details of an illustrative network visualization in accordance with an embodiment of the present system wherein one or more graphs such as graph 350 may be shown within a GUI 300. The graph 350 is depicted beneath a tabular portion 352 relating to tier pair statistics such as bytes and packets 354 and total bytes 356 attributable to given tier pairs. Statistics plotted within the graph 350 may include temporal statistics such as time-varying throughput for all traffic, packets per second for all traffic etc. as well as non-temporal statistics, such as total packets transmitted for a reference node. The graph 350 may be produced as a result of selection of one or more tier pair lines as provided in the tier pair circle 210 during act 170. A time-varying statistic (such as throughput) of a selected tier pairs may be drawn in addition or in place of the graph in response to a selection of a tier pair within the visualization 200. In one embodiment, plot lines for throughput data points that are exactly zero may not be drawn. This may enable identifying when particular tiers are active and/or when they are not. Sliders 360 may be positioned as such or as a paradigm of sliders within the GUI to enable a user to select a range of desired parameters, such as a selection of a specific time region to zoom in upon. For example, the user might know that the ULA of interest occurred at roughly 2:15 PM, so the user might zoom in upon a reasonable time region, such as between 2:10 PM and 2:20 PM as a likely temporal region for traffic related to the ULA of interest. Upon zooming in on a specific time region, the graph 350 may be updated to reflect the traffic contained in that time region. Similarly, tier pair lines of the tier pair circle 210 may also be updated. In accordance with the present system, a tabbed interface 356 may be provided to facilitate accessing different views, such as the GUIs 200, 300.

In one embodiment, an initial view provided may be a tier pair circle that displays all traffic for a trace, for example within a full time range of the trace. The user may utilize a user input device, such as a mouse, to zoom in to a specific time range of interest and/or interact with the tier pair circle or other views as described herein.

In interacting with the GUI provided, the user may select an operation that adds to and/or alters a portion of the initial view. For example, the user may perform an act that results in a break up of the information depicted based on a protocol utilized for the transaction. By providing for filtering the traffic present in a trace according to, for example, highest-level protocols communicated, tier pair circles (e.g., HTTP, SQL, RTSP, etc.) of particular protocol-only traffic may be displayed on a common screen (e.g., see GUI 200) or an alternate screen allowing the user to identify and/or focus on particular traffic of interest. The user may interact with the GUIs provided as described or in other suitable ways as may be readily appreciated in accordance with the present system.

For example, by choosing one or more protocols to drill into further, only traffic relevant to that protocol may be selected. Multiple views such as protocol views may also be supported in accordance with an embodiment of the present system. Additionally, traffic on related protocols may implicitly be selected based on the protocols selected (e.g., choosing DNS requests along with all traffic, and choosing DB traffic associated with HTTP traffic).

In another embodiment shown within a GUI 400, individual packets 452 may be analyzed by, for example, selection of a “decodes” 454 tab. The information provided may include tier pairs (source 456 and destination 458) of the packets 452, packet size 462, packet time 464, communication protocol 466 of a packet, a decode summary 468, etc.

In a further embodiment, once a protocol is selected, a similar view may be presented with a tier pair circle for each user-level action for that particular protocol. These individual actions (e.g., user requests to particular pages such as page1.html, help.html, index.html) may be identified by various ULA extraction methods in accordance with methods described herein or understood to be in accordance with the present system. Selecting a specific protocol like HTTP may also cause any ULAs in a related protocol (e.g., DNS) to be selected as well. Once a ULA is selected, by the above or other filtering processes, network and application performance analysis may now be performed by the user on the one or more ULAs selected during act 190.

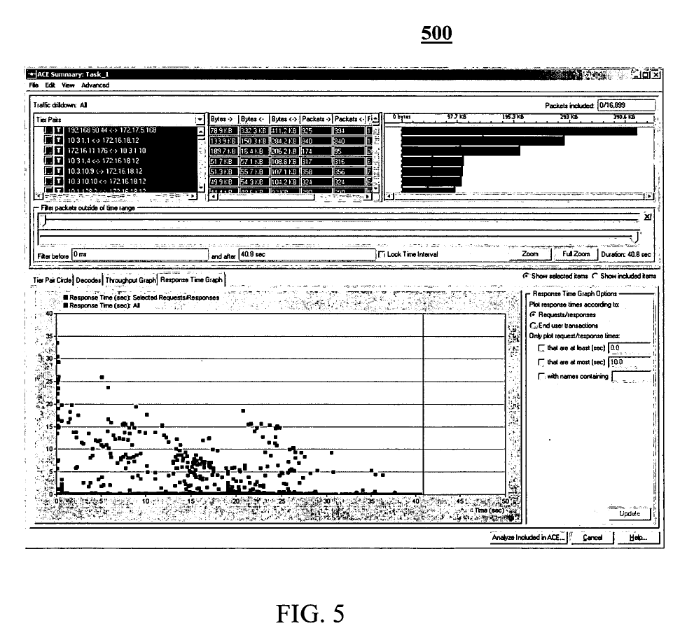

In accordance with the present system, a means may be provided for other targeted analyses of network transactions. For example, a GUI 500 as shown in FIG. 5 may be provided to indicate a graph of response times of selected transactions. Other information, systems and combinations thereof for depicting information related to an activity would readily occur to a person of ordinary skill in the art and are intended to be within the scope of the presently described system. As should be clear from the above description, prior systems may treat all traffic as implicitly related to the performance of a single user-level action, even if unrelated traffic may co-exist with the desired transactions. As such, conclusions about performance may be inaccurate since all traffic is assumed to be related. However, the system in accordance with an embodiment of the present system identifies traffic that is particularly related to user-level actions that has passed through several automatic and user-assisted extraction systems. Accordingly, the present system presumes the opposite of prior system, that is, traffic is unrelated to the transaction of interest unless it is explicitly classified and extracted. Accordingly analysis utilizing transactions, packets, etc., identified in accordance with the present system, will likely result in identifying elements that are related to ULAs of interest.

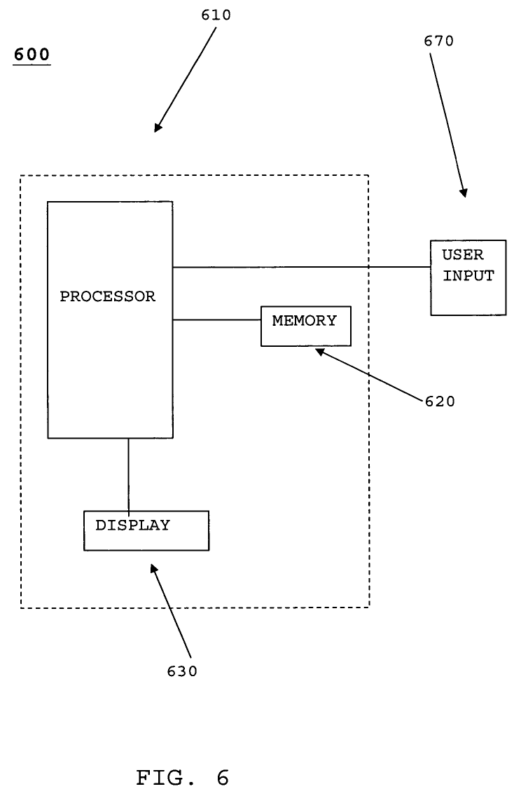

FIG. 6 shows a device 600 in accordance with an embodiment of the present system. The device has a processor 610 operationally coupled to a memory 620, a display 630, and the user input device 670 as discussed above. The memory 620 may be any type of device for storing application data as well as other data, such as trace data, etc. The application data and other data are received by the processor 610 for configuring the processor 610 to perform operation acts in accordance with the present system. The operation acts include controlling at least one of the display 630 to display the GUI described herein. The user input 670 may include a keyboard, mouse, trackball or other devices, including touch sensitive displays, which may be stand alone or be a part of a system, such as part of a personal computer, personal digital assistant, or other display device for communicating with the processor 610 via any type of link, such as a wired or wireless link. The user input device is operable to enable starting of processing acts during act 105 of FIG. 1 as well as enabling interaction with the acts, such as customizing a temporal threshold as discussed above. Clearly the processor 610, memory 620, display 630 and/or user input device 670 may all or partly be a portion of a computer system or other device.

The methods of the present system are particularly suited to be carried out by a computer software program, such program may contain modules corresponding to the individual steps or acts of the methods. Such program may of course be embodied in a computer-readable medium, such as an integrated chip, a peripheral device or memory, such as the memory 620 or other memory coupled to the processor 610.

The computer-readable medium and/or memory 620 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that may store information suitable for use with a computer system may be used as the computer-readable medium and/or memory 620.

Additional memories may also be used. The computer-readable medium, the memory 620, and/or any other memories may be long-term, short-term, or a combination of long-term and short-term memories. These memories configure processor 610 to implement the methods, operational acts, and functions disclosed herein. The memories may be distributed such as residing on one or more servers connected within a network or may reside local to the device 600 and the processor 610, where additional processors may be provided that may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 620, for instance, because the processor 610 may retrieve the information from the network for operation in accordance with the present system.

The processor 610 is capable of providing control signals and/or performing operations in response to input signals from the user input device 670 and executing instructions stored in the memory 620. The processor 610 may be an application-specific or general-use integrated circuit(s). Further, the processor 610 may be a dedicated processor for performing in accordance with the present system or may be a general-purpose processor wherein only one of many functions operates for performing in accordance with the present system. The processor 610 may operate utilizing a program portion, multiple program segments, or may be a hardware device utilizing a dedicated or multi-purpose integrated circuit.

Of course, it is to be appreciated that any one of the above embodiments or processes may be combined with one or more other embodiments or processes or be separated in accordance with the present system. For example, several of the processes discussed for identifying packets may be combined together to identify packets.

Finally, the above-discussion is intended to be merely illustrative of the present system and should not be construed as limiting the appended claims to any particular embodiment or group of embodiments. For example, while much of the illustrative discussion presented focuses on providing a visualization of results of analyzing network traffic in accordance with the present system, the present system may also be readily incorporated as part of some other application that performs a further operation, such as adjusting network resources based on the results without actually providing a visualization of the results. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method of identifying packets within a transmission stream that are related to an activity, the method comprising the acts of:
classifying transactions utilizing characteristics that identify an activity based on user-level actions (ULAs); and
extracting packets of the transactions from the transmission stream that correspond to the activity.

2. The method of claim 1, comprising an act of presenting the extracted packets in a visualization that identifies the packets and source and sink devices of the packets.

3. The method of claim 1, wherein characteristics correspond to class sets.

4. The method of claim 1, wherein the packets are identified from a network trace.

5. The method of claim 1, wherein the act of classifying transactions comprises an act of identifying patterns present in packets to identify related transactions.

6. The method of claim 1, wherein the act of classifying transactions comprises an act of identifying packets that are temporally correlated.

7. The method of claim 1, wherein the characteristics include heuristics related to a communication protocol of the transactions.

8. The method of claim 1, wherein extracting packets comprises an act of identifying DNS requests for a first IP address that occur in temporal proximity to an application request related to one of the plurality of activities.

9. The method of claim 1, wherein the extracting of packets comprises an act of connecting a further activity and the activity as a single activity by identifying a related subsequent user action.

10. The method of claim 1, wherein the extracting of packets comprises an act of correlating a key present in the packets to the activity.

11. The method of claim 1, wherein the extracting of packets comprises an act of correlating traffic across multiple tiers as part of the activity if packets in one tier pair cause corresponding packets in other tier pairs.

12. The method of claim 2, wherein the presenting of the extracted packets comprises an act of presenting a tier pair circle wherein related devices are presented around a circumference of the tier pair circle and packet traffic between devices is indicated by a joining line.

13. The method of claim 12, wherein the joining line is provided with a visual characteristic that indicates a characteristic of related packet traffic.

14. The method of claim 13, wherein the visual characteristic includes at least one of a color and thickness of the joining line.

15. The method of claim 2, comprising an act of receiving a user selection that alters the visualization by providing details related to a selected source and sink.

16. The method of claim 15, wherein the visualization is altered by adding a graph to provide the details.

17. The method of claim 15, wherein the user selection is provided by selecting a temporal period of interest.

18. The method of claim 15, wherein the visualization is altered providing a view based on a communication protocol associated with the extracted packets.

19. An application embodied on a computer readable medium configured to identifying packets within a transmission stream that are related to an activity, the application comprising:
a portion configured to classify transactions based on one or more characteristics that identify an activity; and
a portion configured to extract packets of the transactions from the transmission stream that correspond to the activity.

20. The application of claim 19, wherein the portion configured to extract the packets is configured to extract the packets from a network trace.

21. The application of claim 19, comprising a portion configured to apply heuristics based on observed packet behavior to determine the characteristics of the activity.

22. The application of claim 21, wherein the heuristics include at least one of examining temporal relationships of the packets, examining a communication protocol of the transactions and identifying DNS requests related to the packets.

23. The application of claim 19, wherein the activity is one of a plurality of activities, the application comprising a portion configured to connect two of the plurality of activities as a single activity by identifying a related subsequent user action.

24. The application of claim 19, comprising a portion configured to present the extracted packets in a visualization that identifies the packets and source and sink devices of the packets.

25. The application of claim 24, wherein the portion configured to present the visualization is configured to present a tier pair circle wherein related devices are presented around a circumference of the tier pair circle and packet traffic between devices is indicated by a joining line.

26. The application of claim 25, wherein the joining line is provided with a visual characteristic that indicates a characteristic of related packet traffic.

27. The application of claim 24, comprising a portion configured to receive a user selection that alters the visualization by providing details related to a selected source and sink.

28. The application of claim 27, wherein the portion configured to receive the user selection is configured to receive the user selection indicating a temporal period of interest.
